(19) United States
(12) Patent Application Publication
(10) Pub. No.: US 2023/0102995 A1
(43) Pub. Date: Mar. 30, 2023

(54) OPTICAL COHERENT TRANSCEIVER AND LIGHT-OFF METHOD BY OPTICAL MODULATOR

(71) Applicant: Fujitsu Optical Components Limited, Kawasaki-shi (JP)

(72) Inventors: Tetsuji YAMABANA, Kawasaki (JP); Koji Terada, Yamato (JP)

(73) Assignee: Fujitsu Optical Components Limited, Kawasaki-shi (JP)

(21) Appl. No.: 17/877,259

(22) Filed: Jul. 29, 2022

(30) Foreign Application Priority Data
Sep. 30, 2021 (JP) 2021-162054

(51) Int. Cl. H04B 10/564; H04B 10/40; H04B 10/516; H04B 10/61

(52) U.S. Cl. CPC H04B 10/564; H04B 10/40; H04B 10/5161; H04B 10/616; H04B 10/6165

(57) ABSTRACT

An optical coherent transceiver includes a transmitter and a receiver that share laser light. The transmitter includes a pair of parent MZIs in a modulator, which are parent MZIs configured to perform quadrature modulation on the laser light according to a bias voltage, and two pairs of child MZIs in the modulator, which are child MZIs configured to perform phase modulation on the laser light according to the bias voltage. The transmitter includes a control circuit configured to control the bias voltage to be applied to the parent MZIs and the child MZIs. The control circuit is configured to, when turning light output of the transmitter off, with input of a data signal being set off, control the bias voltage such that a phase difference between the parent MZIs is around 90 degrees and a phase difference between the child MZIs in each of the pairs is 180 degrees.

### CROSS-REFERENCE TO RELATED APPLICATION

This application is based upon and claims the benefit of priority of the prior Japanese Patent Application No. 2021-162054, filed on Sep. 30, 2021, the entire contents of which are incorporated herein by reference.

### FIELD

The embodiments discussed herein are related to an optical coherent transceiver and a light-off method by an optical modulator.

### BACKGROUND

An optical coherent transceiver includes a light source that emits laser light; an optical modulator in an optical transmitter that performs quadrature amplitude modulation on a data signal based on the laser light and outputs transmission light; and an optical receiver that, based on the laser light, demodulates the data signal from reception light that is input. The optical modulator is, for example, an optical modulator that performs quadrature amplitude modulation on transmission light using a Mach-Zehnder modulator (MZM). Furthermore, the optical receiver includes an optical hybrid that obtains a data signal from the reception light by causing interference between the laser light serving as local light and the reception light. The light source is a light source that emits laser light to be input to the optical modulator and laser light serving as local light to be input to the optical hybrid.

The MZM is a quadrature modulator that performs optical modulation on the laser light from the light source using the data signal and includes two child optical modulators that perform phase modulation on the laser light from the light source, a parent optical modulator that performs quadrature modulation on the laser light from the light source, a voltage output unit, and a modulator. Each of the child optical modulators includes a pair of child Mach-Zehnder interferometers (MZI). The child optical modulator performs phase modulation on signal light according to a phase difference between the child MZI and the child MZI. The parent optical modulator includes a pair of parent MZIs, too. The parent optical modulator performs quadrature modulation on the signal light according to a phase difference between the parent MZI and the parent MZI. The voltage output unit is an output unit that applies a bias voltage that adjusts an optimum bias point of each of the MZIs such that each of the MZIs is able to perform modulation appropriately. Note that the optimum bias point of a MZI is a voltage serving as a reference potential of the data signal. The modulator modulates the signal light after quadrature amplitude modulation using the data signal.

In the optical coherent transceiver, the light source that supplies laser light to the optical transmitter and the optical receiver is shared to reduce the size of the device. A light output off function of turning off light output of the optical transmitter is needed to the optical transmitter. The optical receiver, however, shares the light source with the optical transmitter and therefore, when an operation of the light source is stopped by the light output off function of the optical transmitter, it is not possible to continue a receiving operation of obtaining reception light by the optical hybrid. Thus, a method in which an optical attenuator is arranged in an output stage on the side of the optical transmitter and the light output of the optical transmitter is turned off by the optical attenuator while the receiving operation of the optical receiver is continued without stopping the operation of the light source is known.

It is however considered that the size of the optical coherent transceiver increases when the optical attenuator is incorporated and therefore turning off the light output of the optical transmitter by a function of the MZMs is needed. Thus, an optical coherent transceiver with the function of turning off the light output of the optical transmitter by the function of the MZMs is known. In the optical coherent transceiver, it is possible to maintain the high light-off mode by turning off the light output of the optical transmitter by the function of the MZMs without depending on the attenuation rate of the optical attenuator.
Patent Literature 1: Japanese Laid-open Patent Publication No. 2016-149685
Patent Literature 2: Japanese Laid-open Patent Publication No. 2017-116746
Patent Literature 3: Japanese Laid-open Patent Publication No. 2020-17849

In the optical coherent transceiver, to turn off the light output of the optical transmitter without stopping the operation of the light source, the light output of the MZM is turned off by setting the optimum bias point of the parent MZIs in the parent optical modulator at a Null point and adjusting the optimum bias point of the child MZIs in the child optical modulator. In order to maintain the high light-off mode, the optimum bias point of the child MZIs is adjusted in the state where the optimum bias point of the parent MZIs is controlled and set at the Null point.

In the optical coherent transceiver, however, when the optimum bias point of the child MZI is adjusted with the optimum bias point of the parent MZIs being set at the Null point, the optimum bias point of the child MZIs shifts over time. When the optimum bias point of the child MZIs shifts over time, the optimum bias point of the child MZIs is beyond adjustment in a simple peak bottom search. As a result, it is not possible to turn off the light output of the optical transmitter by the function of the MZMs and accordingly it is difficult to maintain the light-off mode by the optical transmitter.

### SUMMARY

According to an aspect of an embodiment, an optical coherent transceiver includes a light source configured to emit laser light, an optical transmitter and an optical receiver. The optical transmitter includes an optical modulator configured to, based on the laser light, perform quadrature amplitude modulation on a data signal and output transmission light. The optical receiver is configured to, based on the laser light, obtain a data signal from a reception signal that is input. The optical transmitter includes at least a pair of parent Mach-Zehnder interferometers in the optical modulator, at least two pairs of child Mach-Zehnder interferometers in the optical modulator and a control circuit. The parent Mach-Zehnder interferometer is configured to perform quadrature modulation on the laser light according to a bias voltage. The child Mach-Zehnder Interferometer is configured to perform phase modulation on the laser light according to the bias voltage. The control circuit is configured to control the bias voltage to be applied to the parent Mach-Zehnder interferometers and the child Mach-Zehnder interferometers. The control circuit is configured to, when turning light output of the optical transmitter off, with input of the data signal being set off, control the bias voltage to be applied to the parent Mach-Zehnder interferometers and the child Mach-Zehnder interferometers such that a phase difference between the parent Mach-Zehnder interferometers is around 90 degrees and a phase difference between the child Mach-Zehnder interferometers in each of the pairs is 180 degrees.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical coherent transceiver according to a first embodiment;

FIG. 2 is a block diagram illustrating an example of a configuration of an optical transmitter;

FIG. 3 is an explanatory view representing an example of a relationship between the light output power of MZIs and the phase difference between the MZIs;

FIG. 4 is an explanatory view illustrating an example of relationships between the light output power of MZIs and a phase difference between the MZIs at the time of modulation and at the time of non-modulation;

FIG. 5 is an explanatory view illustrating an example of constellation at the time of modulation;

FIG. 6 is an explanatory view illustrating an example of constellation at the time of non-modulation;

FIG. 7 is an explanatory view illustrating an example of a process operation of a control circuit that relates to bias control on a Quad point of parent MZIs;

FIG. 8 is an explanatory view illustrating an example of variation in a heater power for searching for an optimum bias point of child MZIs in the case where the optimum bias point of the parent MZIs is Quad point+80 degrees, for example, around a Peak point;

FIG. 9 is an explanatory view illustrating an example of variation in a heater power for searching for an optimum bias point of child MZIs in the case where the optimum bias point of the parent MZIs is Quad point−80 degrees, for example, around a Null point; and

FIG. 10 is a block diagram illustrating an example of a configuration of an optical coherent transceiver according to a second embodiment.

### DESCRIPTION OF EMBODIMENTS

Preferred embodiments of the present invention will be explained with reference to accompanying drawings. Note that the embodiments do not limit the disclosure.

### [a] First Embodiment

Configuration of Optical Coherent Transceiver

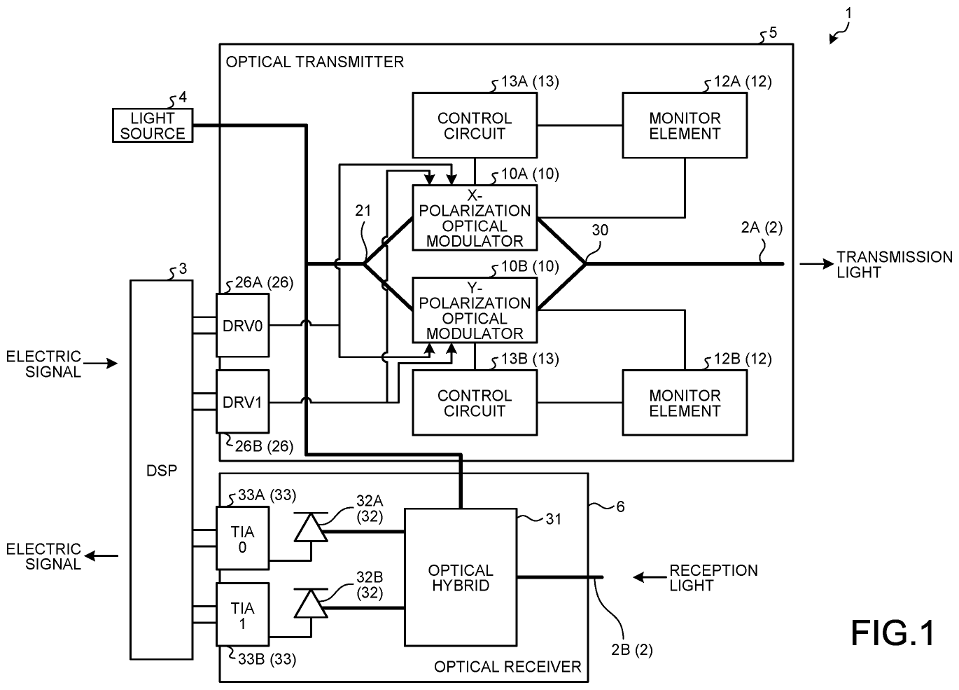

FIG. 1 is a block diagram illustrating an example of a configuration of an optical coherent transceiver 1 according to a first embodiment. The optical coherent transceiver 1 illustrated in FIG. 1 is connected to an optical fiber 2A(2) on an output side and an optical fiber 2B(2) on an input side. The optical coherent transceiver 1 includes a digital signal processor (DSP) 3, a light source 4, an optical transmitter 5, and an optical receiver 6. The DSP 3 is an electric part that executes digital signal processing. The DSP 3 executes, for example, processing, such as coding, on transmission data and outputs data signal corresponding to the transmission data after the execution to the optical transmitter 5. The DSP 3 executes processing, such as decoding, on reception data corresponding to a data signal obtained from the optical receiver 6.

The light source 4 is, for example, an integrated tunable laser assembly (ITLA) that includes, for example, a tunable laser diode, etc., generates light at a given wavelength, and supplies the light to the optical transmitter 5 and the optical receiver 6.

Configuration of Optical Transmitter

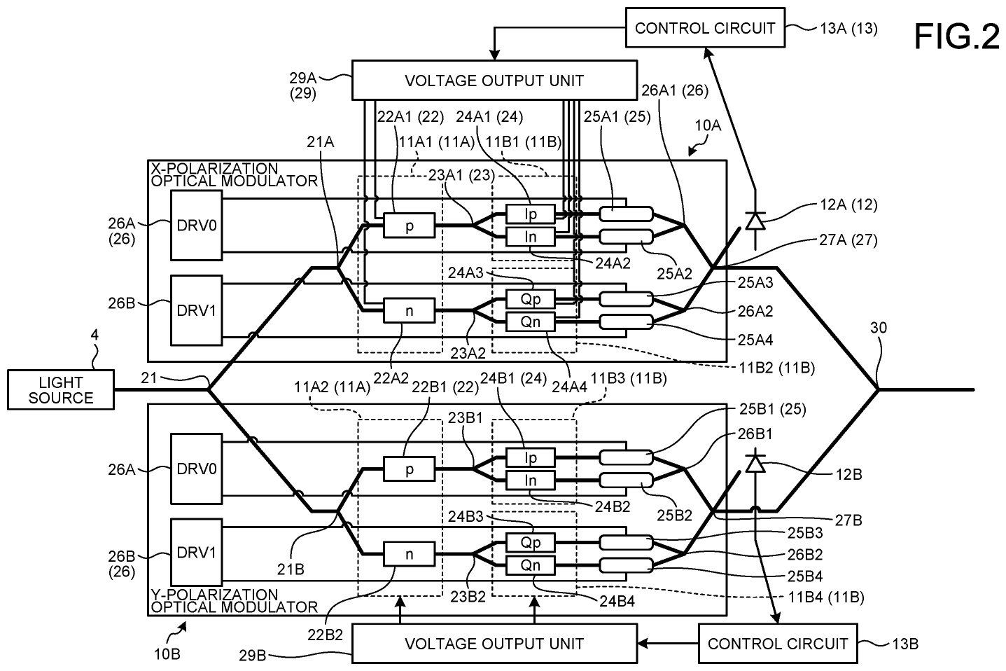

FIG. 2 is a block diagram illustrating an example of a configuration of the optical transmitter 5. The optical transmitter 5 includes an optical modulator 10, a monitor element 12, and a control circuit 13. The optical modulator 10 is, for example, a polarization multiplexing MZM that performs quadrature amplitude modulation. The optical modulator 10 includes, for example, arms and electrodes and, when laser light that is supplied from the light source 4 passes through the arm, applies a data signal (drive voltage signal) corresponding to transmission data from the DSP 3 to the electrode, thereby performing quadrature amplitude modulation on the laser light. The optical modulator 10 generates polarization multiplexing transmission light by performing quadrature amplitude modulation on the laser light. Note that the electrode is a heater electrode that heats the arm in response to application of the drive voltage signal.

The optical modulator 10 includes a first branch 21, a X-polarization optical modulator 10A, a Y-polarization optical modulator 10B, a first multiplexer 30 and two DRVs 26. The first branch 21 branches laser light from the light source 4 to two arms, outputs one of the branched laser lights to the X-polarization optical modulator 10A and outputs the other laser light to the Y-polarization optical modulator 10B.

The X-polarization optical modulator 10A modulates the laser light to signal light of a X-polarized wave by quadrature amplitude modulation, modulates the signal light of the X-polarized wave after quadrature amplitude modulation using a data signal, and outputs the signal light of the X-polarized wave after modulation to the first multiplexer 30. The Y-polarization optical modulator 10B modulates the laser light to a signal light of a Y-polarized wave by quadrature amplitude modulation, modulates the signal light of the Y-polarized wave after quadrature amplitude modulation using a data signal, and outputs the signal light of the Y-polarized wave after modulation to the first multiplexer 30. The first multiplexer 30 multiplexes the signal light of the X-polarized wave from the X-polarization optical modulator 10A and the signal light of the Y-polarized wave from the Y-polarization optical modulator 10B and outputs the polarization multiplexed signal light as the transmission light to the optical fiber 2A.

The DRV 26 is a driver circuit that converts transmission data from the DSP 3 into a data signal and inputs the data signal to the X-polarization optical modulator 10A and the Y-polarization optical modulator 10B. The DRVs 26 include a DRV 26A and a DRV 26B. The DRV 26A that is one of the DRVs 26 converts the transmission data of the DSP 3 into a data signal of an I component that is an in-phase component and inputs the data signal of the I component to the X-polarization optical modulator 10A and the Y-polarization optical modulator 10B. The DRV 26B that is the other DRV converts the transmission data of the DSP 3 into a data signal of a Q component that is a quadrature component and inputs the data signal of the Q component to the X-polarization optical modulator 10A and the Y-polarization optical modulator 10B.

The X-polarization optical modulator 10A includes a second branch 21A, one parent optical modulator 11A1 (11A), two third branches 23, two child optical modulator 11B, and four modulators 25. The X-polarization optical modulator 10A includes two second multiplexers 26, a third multiplexer 27A (27), and a voltage output unit 29A (29). The parent optical modulator 11A1 includes a parent MZI 22A1 (22) and a parent MZI 22A2 (22) in a pair. The second branch 21A branches and outputs the laser light from the first branch 21 to the parent MZI 22A1 and the parent MZI 22A2.

The parent MZI 22A1 in the parent optical modulator 11A1 modulates the laser light according to a bias voltage from the voltage output unit 29A to signal light of an X-polarized wave by quadrature modulation and outputs the signal light of the X-polarized wave after quadrature modulation to a third branch 23A1. The parent MZI 22A2 in the parent optical modulator 11A1 modulates the laser light according to the bias voltage from the voltage output unit 29A to signal light of the X-polarized wave by quadrature modulation and outputs the signal light of the X-polarized wave after quadrature modulation to the third branch 23A2. In other words, the parent optical modulator 11A1 outputs the signal light of the X-polarized wave according to a phase difference between the parent MZI 22A1 and the parent MZI 22A2.

The child optical modulator 11B includes a child optical modulator 11B1 and a child optical modulator 11B2. The third branch 23A1 branches and outputs the signal light of the X-polarized wave after quadrature modulation to a child MZI 24A1 and a child MZI 24A2 in the child optical modulator 11B1. The child MZI 24A1 in the child optical modulator 11B1 performs phase modulation on the signal light of the X-polarized wave according to the bias voltage from the voltage output unit 29A and outputs the signal light of the X-polarized wave after phase modulation to the modulator 25A1. The child MZI 24A2 in the child optical modulator 11B1 performs phase modulation on the signal light of the X-polarized wave according to the bias voltage from the voltage output unit 29A and outputs the signal light of the X-polarized wave after phase modulation to the modulator 25A2. In other words, the child optical modulator 11B1 performs phase modulation on the signal light of the X-polarized wave according to a phase difference between the child MZI 24A1 and the child MZI 24A2.

The modulator 25A1 modulates the signal light of the X-polarized wave after phase modulation using the data signal of the I component and outputs the signal light of the I component of the X-polarized wave after modulation to the second multiplexer 26A1. The modulator 25A2 modulates the signal light of the X-polarized wave after phase modulation using the data signal of the I component and outputs the signal light of the I component of the X-polarized wave after modulation to the second multiplexer 26A1. The second multiplexer 26A1 multiplexes the signal light of the I component of the X-polarized wave after modulation from the modulator 25A1 and the signal light of the I component of the X-polarized wave after modulation from the modulator 25A2 and outputs the signal light of the I component of the X-polarized wave after multiplexing to the third multiplexer 27A.

The third branch 23A2 branches and outputs the signal light of the X-polarized wave after quadrature modulation to a child MZI 24A3 and a child MZI 24A4 in the child optical modulator 11B2. The child MZI 24A3 in the child optical modulator 11B2 performs phase modulation on the signal light of the X-polarized wave according to the bias voltage from the voltage output unit 29A and outputs the signal light of the X-polarized wave after phase modulation to the modulator 25A3. The child MZI 24A4 in the child optical modulator 11B2 performs phase modulation on the signal light of the X-polarized wave according to the bias voltage from the voltage output unit 29A and outputs the signal light of the X-polarized wave after phase modulation to the modulator 25A4. In other words, the child optical modulator 11B2 performs phase modulation on the signal light of the X-polarized wave according to a phase difference between the child MZI 24A3 and the child MZI 24A4.

The modulator 25A3 modulates the signal light of the X-polarized wave after phase modulation using the data signal of the Q component and outputs the signal light of the Q component of the X-polarized wave after modulation to the second multiplexer 26A2. The modulator 25A4 modulates the signal light of the X-polarized wave after phase modulation using the data signal of the Q component and outputs the signal light of the Q component of the X-polarized wave after modulation to the second multiplexer 26A2. The second multiplexer 26A2 multiplexes the signal light of the Q component of the X-polarized wave after modulation from the modulator 25A3 and the signal light of the Q component of the X-polarized wave after modulation from the modulator 25A4 and outputs the signal light of the Q component of the X-polarized wave after multiplexing to the third multiplexer 27A.

The third multiplexer 27A multiplexes the signal light of the I component of the X-polarized wave from the second multiplexer 26A1 and the signal light of the Q component of the X-polarized wave from the second multiplexer 26A2 and outputs the signal light of the IQ components of the X-polarized wave after multiplexing to the first multiplexer 30.

The Y-polarization optical modulator 10B includes a second branch 21B, one parent optical modulator 11A2 (11A), two third branches 23B1 and 23B2, two child optical modulators 11B3 and 11B4, and four modulators 25. The Y-polarization optical modulator 10B further includes two second multiplexers 26B1 and 26B2, a third multiplexer 27B (27), and a voltage output unit 29B (29). The parent optical modulator 11A2 includes a parent MZI 22B1 (22) and a parent MZI 22B2 (22) in a pair. The second branch 21B branches and outputs the laser light from the first branch 21 to the parent MZI 22B1 and the parent MZI 22B2.

The parent MZI 22B1 in the parent optical modulator 11A2 modulates the laser light according to a bias voltage from the voltage output unit 29B to signal light of a Y-polarized wave by quadrature modulation and outputs the signal light of the Y-polarized wave after quadrature modulation to the third branch 23B1. The parent MZI 22B2 in the parent optical modulator 11A2 modulates the laser light according to the bias voltage from the voltage output unit 29B to signal light of the Y-polarized wave by quadrature modulation and outputs the signal light of the Y-polarized wave after quadrature modulation to the third branch 23B2. In other words, the parent optical modulator 11A2 outputs the signal light of the Y-polarized wave according to a phase difference between the parent MZI 22B1 and the parent MZI 22B2.

The child optical modulator 11B includes the child optical modulator 11B3 and the child optical modulator 11B4. The third branch 23B1 branches and outputs the signal light of the Y-polarized wave after quadrature modulation to a child MZI 24B1 and a child MZI 24B2 in the child optical modulator 11B3. The child MZI 24B1 in the child optical modulator 11B3 performs phase modulation on the signal light of the Y-polarized wave according to the bias voltage from the voltage output unit 29B and outputs the signal light of the Y-polarized wave after phase modulation to the modulator 25B1. The child MZI 24B2 in the child optical modulator 11B3 performs phase modulation on the signal light of the Y-polarized wave according to the bias voltage from the voltage output unit 29B and outputs the signal light of the Y-polarized wave after phase modulation to the modulator 25B2. In other words, the child optical modulator 11B3 performs phase modulation on the signal light of the Y-polarized wave according to a phase difference between the child MZI 24B1 and the child MZI 24B2.

The modulator 25B1 modulates the signal light of the Y-polarized wave after phase modulation using the data signal of the I component and outputs the signal light of the I component of the Y-polarized wave after modulation to the second multiplexer 26B1. The modulator 25B2 modulates the signal light of the Y-polarized wave after phase modulation using the data signal of the I component and outputs the signal light of the I component of the Y-polarized wave after modulation to the second multiplexer 26B1. The second multiplexer 26B1 multiplexes the signal light of the I component of the Y-polarized wave after modulation from the modulator 25B1 and the signal light of the I component of the Y-polarized wave after modulation from the modulator 25B2 and outputs the signal light of the I component of the Y-polarized wave after multiplexing to the third multiplexer 27B.

The third branch 23B2 branches and outputs the signal light of the Y-polarized wave after quadrature modulation to a child MZI 24B3 and a child MZI 24B4 in the child optical modulator 11B4. The child MZI 24B3 in the child optical modulator 11B4 performs phase modulation on the signal light of the Y-polarized wave according to the bias voltage from the voltage output unit 29B and outputs the signal light of the Y-polarized wave after phase modulation to the modulator 25B3. The child MZI 24B4 in the child optical modulator 11B4 performs phase modulation on the signal light of the Y-polarized wave according to the bias voltage from the voltage output unit 29B and outputs the signal light of the Y-polarized wave after phase modulation to the modulator 25B4. In other words, the child optical modulator 11B4 performs phase modulation on the signal light of the Y-polarized wave according to a phase difference between the child MZI 24B3 and the child MZI 24B4.

The modulator 25B3 modulates the signal light of the Y-polarized wave after phase modulation using the data signal of the Q component and outputs the signal light of the Q component of the Y-polarized wave after modulation to the second multiplexer 26B2. The modulator 25B4 modulates the signal light of the Y-polarized wave after phase modulation using the data signal of the Q component and outputs the signal light of the Q component of the Y-polarized wave after modulation to the second multiplexer 26B2. The second multiplexer 26B2 multiplexes the signal light of the Q component of the Y-polarized wave after modulation from the modulator 25B3 and the signal light of the Q component of the Y-polarized wave after modulation from the modulator 25B4 and outputs the signal light of the Q component of the Y-polarized wave after multiplexing to the third multiplexer 27B.

The third multiplexer 27B multiplexes the signal light of the I component of the Y-polarized wave from the second multiplexer 26B1 and the signal light of the Q component of the Y-polarized wave from the second multiplexer 26B2 and outputs the signal light of the IQ components of the Y-polarized wave after multiplexing to the first multiplexer 30.

The first multiplexer 30 multiplexes the signal light of the IQ components of the X-polarized wave from the third multiplexer 27A and the signal light of the IQ components of the Y-polarized wave from the third multiplexer 27B and outputs the polarization multiplexed signal light as the transmission light to the optical fiber 2A.

The voltage output unit 29 applies the bias voltage that adjusts the optimum bias points of the parent MZI 22 and the child MZI 24 to each parent MZI 22 and each child MZI 24. Note that a dither signal that is used for ABC to be described below is added to the bias voltage. The voltage output unit 29 includes the voltage output unit 29A and the voltage output unit 29B. The voltage output unit 29A applies the bias voltage to the parent MZIs 22 and the child MZIs 24 in the parent optical modulator 11A1, the child optical modulator 11B1 and the child optical modulator 11B2 in the X-polarization optical modulator 10A. The voltage output unit 29B applies the bias voltage to the parent MZIs 22 and the child MZIs 24 in the parent optical modulator 11A2, the child optical modulator 11B3 and the child optical modulator 11B4 in the Y-polarization optical modulator 10B.

The monitor element 12 is arranged in an output stage of the third multiplexer 27, performs electric conversion on signal light of a normal phase of the third multiplexer 27 after quadrature amplitude modulation, and detects a response of a light output power to the dither signal from the signal light. The monitor element 12 includes a monitor element 12A and a monitor element 12B. The monitor element 12A performs electric conversion on the signal light of a normal phase of the third multiplexer 27A after quadrature amplitude modulation, and detects a response of a light output power to the dither signal from the signal light. The monitor element 12B performs electric conversion on the signal light of a normal phase of the third multiplexer 27B after quadrature amplitude modulation, and detects a response of a light output power to the dither signal from the signal light.

The control circuit 13 controls the voltage output unit 29 based on the responses of the light output powers to the dither signal that are detected by the monitor element 12 such that the bias voltage of each parent MZI 22 and each child MZI 24 are at the optimum bias points. The control circuit 13 includes a control circuit 13A and a control circuit 13B. The control circuit 13A controls the voltage output unit 29A in the X-polarization optical modulator 10A based on the response of the light output power to the dither signal that is detected by the monitor element 12A. The control circuit 13B controls the voltage output unit 29B in the Y-polarization optical modulator 10B based on the response of the light output power to the dither signal that is detected by the monitor element 12B.

Configuration of Optical Receiver

The optical receiver 6 receives polarization multiplexed signal light from the optical fiber 2B and demodulates desired reception light from the polarization multiplexed signal light using laser light (local light emission) that is supplied from the light source 4. The optical receiver 6 converts the demodulated reception light to a data signal and outputs reception data of the data signal after conversion to the DSP 3. The optical receiver 6 includes an optical hybrid 31, two photoelectric converters 32, and two TIAs 33. The optical hybrid 31 causes interference between the polarization multiplexed signal light and the local light emission from the light source 4 and extracts reception light of an I component and a Q component of the same wavelength as that of the local light emission from the polarization multiplexed signal light.

The photoelectric converter 32 electrically converts the reception light that is extracted by the optical hybrid 31 into a data signal. The photoelectric converters 32 include a photoelectric converter 32A and a photoelectric converter 32B. The photoelectric converter 32A converts the reception light of the I component that is extracted by the optical hybrid 31 into a data signal of the I component. The photoelectric converter 32B converts the reception light of the Q component that is extracted by the optical hybrid 31 into a data signal of the Q component.

The TIAs 33 amplify the data signals from the respective photoelectric converters 32, digitally convert the data signals after amplification, and outputs reception data after digital conversion to the DSP 3. The TIAs 33 include a TIA 33A and a TIA 33B. The TIA 33A amplifies the data signal of the I component from the photoelectric converter 32A, digitally converts the data signal of the I component after amplification, and outputs reception data of the I component after digital conversion to the DSP 3. The TIA 33B amplifies the electric signal of the Q component from the photoelectric converter 32B, digitally converts the electric signal of the Q component after amplification, and outputs reception data of the Q component after digital conversion to the DSP 3. The DSP 3 acquires reception data using the reception data of the I component acquired from the TIA 33A and the reception data of the Q component acquired from the TIA 33B.

The optical coherent transceiver 1 has a function of turning off light output of the optical transmitter 5 using the function of the optical modulator 10 in the optical transmitter 5 while supplying laser light from the light source 4 to the optical transmitter 5 and the optical receiver 6 without stopping the operation of the light source 4.

When the light output of the optical transmitter 5 is being on, after performing control to set the optimum bias point of the parent MZIs 22 in the parent optical modulator 11A at a Quad point, the control circuit 13 adjusts the bias voltage such that the optimum bias point of the child MZIs 24 in the child optical modulator 11B is at a Null point. The control circuit 13 controls the voltage output unit 29 to adjust the bias voltage. The case where the optimum bias point of each of the child MZIs 24 in the child optical modulator 11B is at the Null point is, for example, the state in which the phase difference between the child MZI 24A1 and the child MZI 24A2 of the same polarization is 180 degrees. The case where the optimum bias point of each of the parent MZIs 22 in the parent optical modulator 11A is at the Quad point is, for example, the state in which the phase difference between the parent MZI 22A1 and the parent MZI 22A2 is 90 degrees.

When the light output of the optical transmitter 5 is being on, with the bias point of the parent MZIs 22 being controlled and set at the Quad point, the control circuit 13 adds infinitesimal variation (dither signal) to the bias voltage in order to maintain the bias point of each of the child MZIs 24 at the Null point. Furthermore, the control circuit 13 monitors a response of the light output power to the dither signal. The control circuit is able to perform bias control on the optimum bias point of the child MZIs 24 to minimize the response of the light output power. Note that, because the optimum bias point of each of the parent MZIs 22 and each of the child MZIs 24 varies according to operation conditions and variation over time, the bias control uses, for example, ABC (Auto Bias Control) search of searching for the optimum bias point. As a result, the control circuit 13 is able to adjust the optimum bias points of the respective parent MZIs 22 and the respective child MZIs 24 by ABC while keeping communication operations of the optical transmitter 5 and the optical receiver 6.

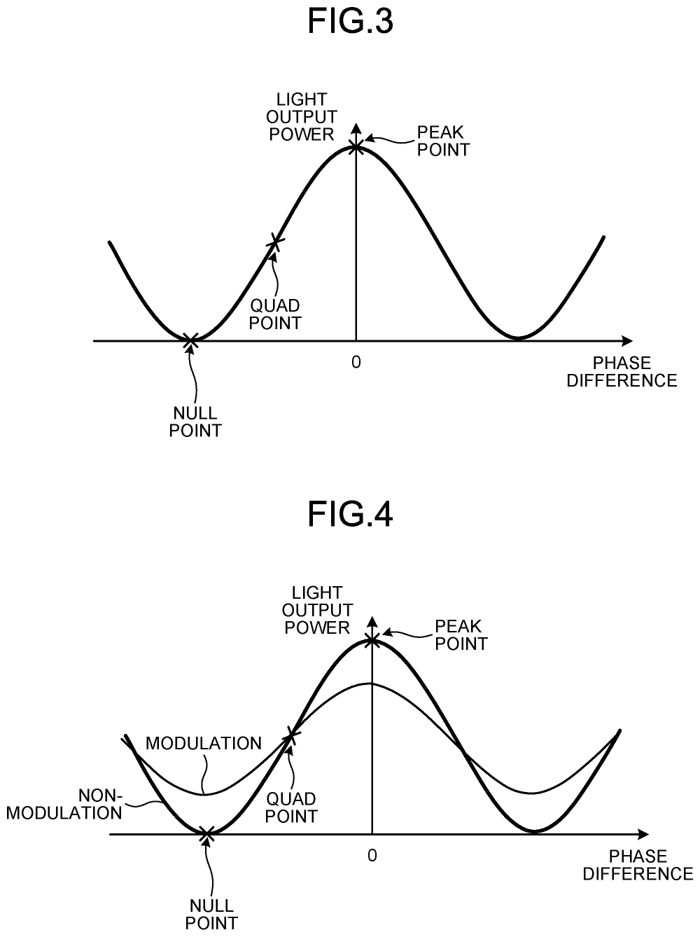

FIG. 3 is an explanatory view representing an example of a relationship between the light output power of MZIs and the phase difference between the MZIs. Note that the vertical axis represents the light output power of a pair of MZIs and the horizontal axis represents the phase difference between the MZIs in a pair. The Null point is a bias point at which the light output power of the pair of MZIs is at minimum and the phase difference between the MZIs in a pair is 180 degrees. The Peak point is a bias point at which the light output power of the pair of MZIs is at maximum and the phase difference between the MZIs in a pair is 0 degrees. The Quad point is a bias point at which the light output power of the pair of MZIs is ½ of the maximum and the phase difference between the MZIs in a pair is 90 degrees.

Bias Control on Child MZI

To the child MZIs 24, the Null point at which the light output power is at minimum is the optimum bias point. When executing bottom search such that the optimum bias point of the child MZIs 24 is at the Null point, the control circuit 13 shift the phase to change the phase in a direction in which the light output power lowers. The operation of “shifting the phase”, however, deteriorates the signal quality so that the phase variation is minimized. Thus, a technique of adding a small dither signal to the bias voltage and extracting a maximum response is used. In bias control on the child MZIs 24, a dither signal of a frequency component f0 is added to the bias voltage and detecting a synchronization signal of the dither signal from a response of the light output power. When a dither signal of the bottom center is added to the bias voltage, the response of the light output power varies with a doubled frequency. Accordingly, when the bias voltage has a shift from the bottom, the light output power distorts (two components of a f0 component and a 2*f0 component appear). The control circuit 13 extracts a synchronization signal of the dither signal from the response of the light output power and performs feedback control such that the synchronization signal is zero, thereby approximating the optimum bias point of the child MZIs 24 to the Null point.

Note that, in bias control on the child MZIs 24, control is performed such that the optimum bias point of the child MZIs 24 is at the Null point and, for example, when the optimum bias point of the parent MZIs 22 is around the Peak point or the Null point, an operation of searching for the Null point of the child MZIs 24 is unstable. Thus, in bias control on the child MZIs 24 in the first embodiment, setting the optimum bias point of the parent MZIs 22 at a point around the Quad point makes it possible to stabilize the bottom search operation of searching for the Null point of the child MZIs 24.

When the light output of the optical transmitter 5 is being on, the control circuit 13 executes ABC such that the optimum bias point of the parent MZIs 22 is at the Quad point and the optimum bias point of the child MZIs 24 is at the Null point. On the other hand, when the light output of the optical transmitter 5 is being off, the control circuit 13 executes ABC such that the optimum bias point of the parent MZIs 22 is around the Quad point and the optimum bias point of the child MZIs 24 is at the Null point. Note that, when the light output of the optical transmitter 5 is being off, compared to the case where the light output of the optical transmitter 5 is being on, the optimum bias point of the parent MZIs 22 need not be at the Quad point strictly and it may be around the Quad point. Thus, while the response of the light output power of the normal phase output of the first multiplexer 30 has to be used when the light output of the optical transmitter 5 is being on, the response of the light power of the reversed-phase output of the first multiplexer 30 may be used when the light output of the optical transmitter 5 is being off.

At the time of modulation with the light output of the optical transmitter 5 being on, after setting the optimum bias point of the parent MZIs 22 at the Quad point, the control circuit 13 executes a first search to be described below at the time of modulation such that the optimum bias point of the child MZIs 24 is at the Null point. The time of modulation is the case where the light output of the optical transmitter 5 is being on and the modulator 25 is being on. The case where the modulator 25 is being on is the state in which application of a data signal is on. On the other hand, at the time of non-modulation when a function of turning off the light output of the optical transmitter 5 is started, after setting the optimum bias point of the parent MZIs 22 at a point around the Quad point, the control circuit 13 executes a second search to be described below at the time of non-modulation such that the optimum bias point of the child MZIs 24 is at the Null point. The time of non-modulation is the case where the light output of the optical transmitter 5 is being off and the modulator 25 is being off. The case where the modulator 25 is being off is the state in which application of a data signal is set off.

FIG. 4 is an explanatory view illustrating an example of relationships between the light output power of MZIs and a phase difference between the MZIs at the time of modulation and at the time of non-modulation. At the time of modulation, there is a characteristic that the range of the light output power is narrow. On the other hand, at the time of non-modulation, there is a characteristic that the range of the light output power is wide.

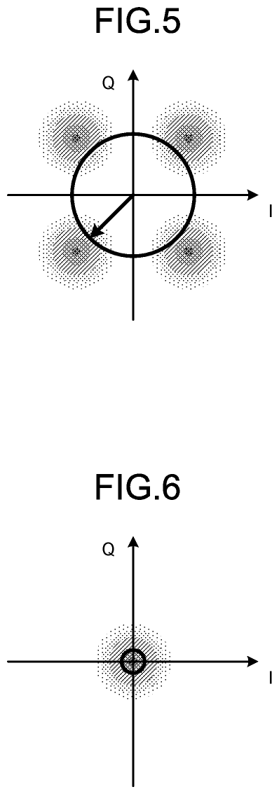

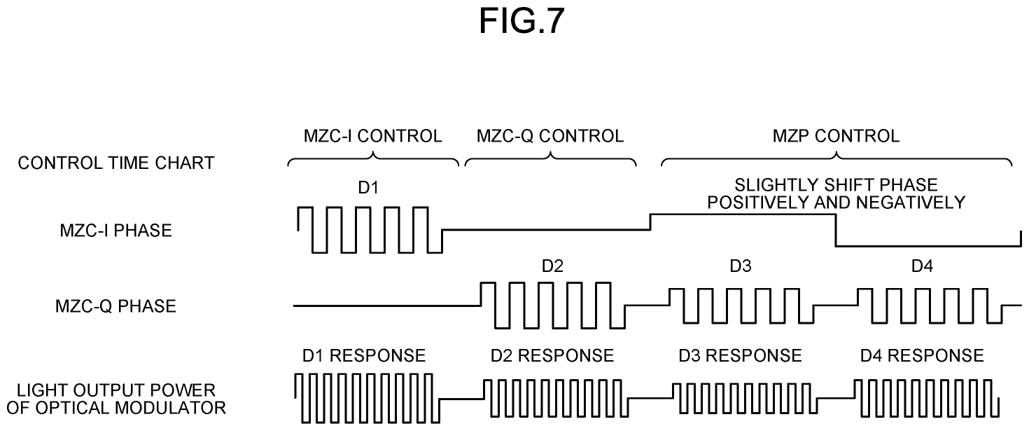

FIG. 5 is an explanatory view illustrating an example of constellation at the time of modulation. For the convenience of illustration, constellation of QPSK is exemplified as the constellation. As for the origin (I,Q) of constellation, the optimum bias point of the child MZIs 24 corresponds to the Null point and the light output power is proportional to the distance from the origin. When the optimum bias point of the child MZIs 24 deviates from the Null point, the position of the symbol shifts. Furthermore, when the optimum bias point of the parent MZIs 22 deviates from the Quad point, the positional relationship of the symbols distorts. According to the constellation at the time of modulation illustrated in FIG. 5, the inside of the circle in the average distance from the origin represents light power that can be monitored. As for the light output power of the child MZIs 24 at the time of modulation, the light output power is determined roughly by the average of light output power in each symbol. Note that, strictly, the transient state of transition between symbols also affects the average of light output power but the conclusion is the same.

FIG. 6 is an explanatory view illustrating an example of constellation at the time of non-modulation. According to constellation at the time of non-modulation illustrated in FIG. 6, the optical power reduces to be around zero. When the optimum bias point of the child MZIs 24 is adjusted to be around the Null point, the light output power of the child MZIs 24 at the time of non-modulation is approximately zero.

Thus, at the time of modulation and at the time of non-modulation, the control circuit 13 has the same aspect in that the control circuit 13 is able to put the optimum bias point of the child MZIs 24 in the Null point by a bottom search; however, because “how much the light output power varies when the phase is shifted” varies between the time of modulation and the time of non-modulation, the loop gain of feedback control has to be changed as appropriate between the time of modulation and the time of non-modulation.

Thus, in the first search that is executed at the time of modulation, the light output power whose characteristic is in that the variation reduces is the subject, the response of the light output power to the dither signal is enhanced, and the Null point of the child MZIs 24 is searched for by a first loop gain. As a result, the control circuit 13 is able to accurately search for the Null point of the child MZIs 24 at the time of modulation.

On the other hand, in the second search that is executed at the time of non-modulation, the light output power whose characteristic is in that the variation increases is the subject, the response of the light output power to the dither signal is lessened, and the Null point of the child MZIs 24 is searched for by a second loop gain. Note that the second loop gain is a loop gain smaller than the first loop gain. As a result, the control circuit 13 is able to search for the Null point of the child MZIs 24 at the time of non-modulation.

Light Output Power of Optical Modulator

For example, operations of the X-polarization optical modulator 10A at the time of non-modulation are assumed. Note that, because operations of the Y-polarization optical modulator 10B at the time of non-modulation are the same as those of the X-polarization optical modulator 10A at the time of non-modulation, redundant description thereof will be omitted. The phase differences of the respective MZIs in the X-polarization optical modulator 10A are represented by MZC-I, MZC-Q, and MZP. The phase difference MZC-I is, for example, in the case of the child optical modulator 11B1, a phase difference Φ_{I} between the child MZI 24A1 and the child MZI 24A2 in the child optical modulator 11B1. The phase difference MZC-Q is, for example, in the case of the child optical modulator 11B2, a phase difference Φ_{Q} between the child MZI 24A3 and the child MZI 24A4 in the child optical modulator 11B2. The phase difference MZP is, for example, in the case of the parent optical modulator 11A1, a phase difference Φ_{P} between the parent MZI 22A1 and the parent MZI 22A2 in the parent optical modulator 11A1. A light output power POUT in the X-polarization optical modulator 10A is proportional to, for example, the expression of Expression 1.

Pₒᵤₜ∝cos²φ_{I}+cos²φ_{Q}−2cos2φ_{P}·cosφ_{I}·cosφ_{Q} (1)

Under the condition that the optimum bias point of the child MZIs 24 is at the Null point and the optimum bias point of the parent MZIs 22 is at the Quad point, the phase difference Φ_{I} between the child MZIs 24, the phase difference Φ_{Q} between the child MZIs 24, and the phase difference Φ_{P} between the parent MZIs 22 are as expressed by Expression 2, where n, m and 1 are integers.

$${φ}_{I} = \frac{π}{2} + n π , {φ}_{Q} = \frac{π}{2} + m π , {φ}_{P} = \frac{π}{4} + \frac{l π}{2} \qquad ( 2 )$$

For better assumption of calculation, the phase difference of the light power equation is replaced as represented by Expression 3.

$${φ}_{I}^{′} = {φ}_{I} - \frac{π}{2} , {φ}_{Q}^{′} = {φ}_{Q} - \frac{π}{2} , {φ}_{P}^{′} = {φ}_{P} - \frac{π}{4} \qquad ( 3 )$$

When the phase difference of Expression 3 is assigned, the expression for the light output power is as expressed by Expression 4.

Expression 4

Pₒᵤₜ∝sin²φ′_{I}+sin²φ′_{Q}−2sin2φ′_{P}·sinφ′_{I}·sin φ′_{Q} (4)

In ABC, an initial phase difference is set to be around Φ′_{I}=Φ′_{Q}=Φ′_{P}=0 based on the phase property of each MZI that is known in advance and feedback control is performed to approximate the control block to Φ′_{I}=Φ′_{Q}=Φ′_{P}=0 that is one of phase bias optimum conditions.

Bias Control on Parent MZI

Bias control of setting the optimum bias point of the parent MZIs 22 at the Quad point will be described next. The control circuit 13 superimposes a dither signal on the bias voltage of each MZI. First of all, in a first period, the control circuit 13 executes MZC-I control in which superimposition of a dither signal of a MZC-Q phase is set off and superimposition of a dither signal of a MZC-I phase (D1) is set on. Note that setting superimposition of the dither signal of the MZC-Q phase off refers to the state in which superimposition of the dither signal on the bias voltage to be applied to each MZI 24 on a Q-component side in the child optical modulator 11B is set off. Setting superimposition of the dither signal of the MZC-I phase on refers to the state in which superimposition of the dither signal on the bias voltage to be applied to each MZI 24 on a I-component side in the child optical modulator 11B is set on.

In a second period after the elapse of the first period, the control circuit 13 executes MZC-Q control in which superimposition of the dither signal of the MZC-I phase is set off and superimposition of the dither signal of the MZC-Q phase (D2) is set on. Note that setting superimposition of the dither signal of the MZC-I phase off refers to the state in which superimposition of the dither signal on the bias voltage to be applied to each MZI 24 on the I-component side in the child optical modulator 11B is set off. Setting superimposition of the dither signal of the MZC-Q phase on refers to the state in which superimposition of the dither signal on the bias voltage to be applied to each MZI 24 on the Q-component side in the child optical modulator 11B is set on.

In a third period after the elapse of the second period, the control circuit 13 executes MZP control in which a reference signal of the MZC-I phase is increased in a positive direction by a given degree and superimposition of the dither signal of the MZC-Q phase (D3) is set on. Furthermore, in a fourth period after the elapse of the third period, the control circuit 13 executes MZP control in which the reference signal of the MZC-I phase is lowered in a negative direction by a given degree and superimposition of the dither signal of the MZC-Q phase (D4) is set on. Note that the first period, the second period, the third period and the fourth period have the same duration.

Using a band pass filter (BPF) not illustrated in the drawings, the control circuit 13 detects, as MZC-I control information, a synchronization signal of a light output power response (D1 response) to the dither signal D1 that is superimposed in the first period. Furthermore, using the BPF, the control circuit 13 detects, as MZC-Q control information, a synchronization signal of a light output power response (D2 response) to the dither signal D2 that is superimposed in the second period. Furthermore, using the BPF, the control circuit 13 detects a synchronization signal of a light output power response (D3 response) to the dither signal D3 that is superimposed in the third period. Furthermore, using the BPF, the control circuit 13 detects a synchronization signal of a light output power response (D4 response) to the dither signal D4 that is superimposed in the fourth period. The control circuit 13 then obtains MZP control information by (D3 response-D4 response). Based on the MZC-I control information, the MZC-Q control information and the MZP control information, the control circuit 13 performs bias adjustment such that the optimum bias point of the parent MZIs 22 is at the Quad point.

The following description can be given numerically. When a bias voltage of ±Φ_{dI_DC} is added to the MZC-I phase and a dither signal of Φ_{dQ} is added to the MZC-Q phase, the expression for the light output power is proportional to Expression 5.

Pₒᵤₜ₊∝sin²(φ′_{I}+φ_{dI_DC})+sin²(φ′_{Q}+φ_{dQ})+2sinφ′_{P}·sin(φ′_{I}+φ_{dI_DC})·sinφ′_{Q}+φ_{dQ}) Pₒᵤₜ₊∝sin²(φ′_{I}−φ_{dI_DC})+sin²(φ′_{Q}−φ_{dQ})+2sinφ′_{P}·sin(φ′_{I}−φ_{dI_DC})·sinφ′_{Q}−φ_{dQ}) (5)

The control circuit 13 extracts a synchronization component (synchronization signal) from each dither signal Φ_{dQ} as expressed by Expression 6, where f(Φ) is, for example, the result of extracting the component synchronized with a dither frequency from Φ.

f(φ_{dQ})(sin2φ′_{Q}+2sin2φ′_{P}·sin(φ′_{I}+φ_{dI_DC})·cosφ′_{Q}) f(φ_{dQ})(sin2φ′_{Q}+2sin2φ′_{P}·sin(φ′_{I}−φ_{dI_DC})·cosφ′_{Q}) (6)

Subtraction of the two expressions in Expression 6 is as expressed by Expression 7. Approximation to the optimum bias point (Φ′_{I}=Φ′_{Q}=Φ′_{P}=0) leads to approximate proportion to Φ′_{P} and therefore linearly feedback control is enabled. The gradient changes with modulation as in the case of child MZIs 24 and the basic idea is the same.

$$f ( {φ}_{dQ} ) ( sin 2 {φ}_{Q}^{′} + 2 sin 2 {φ}_{P}^{′} \cdot sin ( {φ}_{I}^{′} + {φ}_{dI \_ DC} ) \cdot cos {φ}_{Q}^{′} ) - f ( {φ}_{dQ} ) ( sin 2 {φ}_{Q}^{′} + 2 sin 2 {φ}_{P}^{′} \cdot sin ( {φ}_{I}^{′} - {φ}_{dI \_ DC} ) \cdot cos {φ}_{Q}^{′} ) = 4 {φ}_{dI \_ DC} \cdot f ( {φ}_{dQ} ) \cdot sin 2 {φ}_{P}^{′} \cdot cos {φ}_{I}^{′} \cdot cos {φ}_{Q}^{′} \qquad ( 7 )$$

The expression for the light output power is as expressed by Expression 8.

Pₒᵤₜ∝sin²φ′_{I}+sin²φ′_{Q}+2sin2φ′_{P}·sinφ′_{I}·sin φ′_{Q} (8)

The expression for the light output power in the case where the optimum bias point of the parent MZIs 22 is at the Quad point is as expressed by Expression 9. As a result, I and Q are independent and performing a bottom search on each of I and Q makes it possible to keep the optimum bias point of the child MZIs 24 at the Null point.

Pₒᵤₜ∝sin²φ′_{I}+sin²φ′_{Q} (9)

Problem in Setting Optimum Bias Point of Parent MZIs at Null Point

It can be assumed that, when the function of turning off the light output of the optical transmitter 5 is executed, for example, bias control is performed to set the optimum bias point of the parent MZIs 22 in the parent optical modulator 11A at the Null point and set the optimum bias point of the child MZIs 24 at the Null point. In other words, in principle, it can be assumed that the phase difference between the parent MZIs 22 is set at 180 degrees and the phase difference between the child MZIs 24 is set at 180 degrees to set the light output of the optical transmitter 5 at zero.

The expression for the light output power in the case where the optimum bias point of the parent MZIs 22 is at the Null point is as expressed by Expression 10. According to Equation, when the condition of Φ′_{I}=−Φ′_{Q} is met, the light output power is minimized and thus stabilization is not enabled.)

Pₒᵤₜ∝sin²φ′_{I}+sin²φ′_{Q}+2sin φ′_{I}·sinφ′_{Q}(sinφ′_{I}+sin φ′_{Q})² 910)

Under the condition that the IQ phase is zero at the Null point, when the optimum bias point of the parent MZIs 22 is at the Quad point, stabilization is enabled at the minimum point (Null point) of the child MZIs 24. For example, when the optimum bias point of the parent MZIs 22 slightly shifts from the Quad point, that is, when the optimum bias point of the parent MZIs 22 is around the Quad point, the optimum bias point of the child MZIs 24 is stabilized at the Null point. When the optimum bias point of the parent MZIs 22 is at the Null point, however, the optimum bias point of the child MZIs 24 shifts over time while f Φ′_{I}=−Φ′_{Q}. As a result, there is a risk that, while the light output power is kept at minimum, phase control would reach the limit at some point and collapse.

Thus, a problem in performing bias control to set the optimum bias point of the child MZIs 24 at the Null point in the case where the optimum bias point of the parent MZIs 22 is around the Null point or the Peak point when the function of turning the light output of the optical transmitter 5 off is executed will be described more in detail.

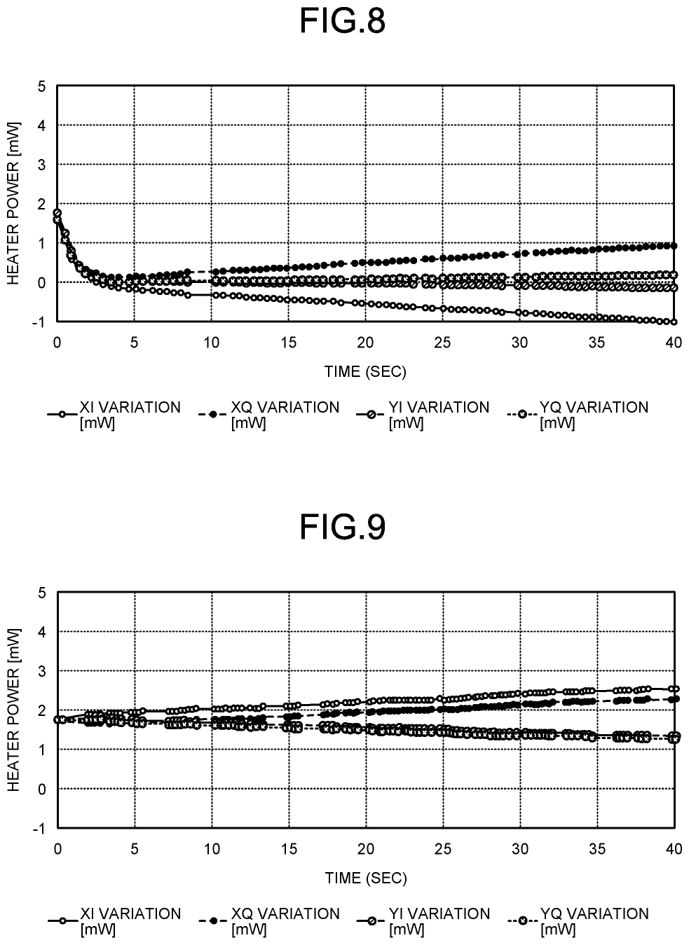

A bottom search is executed such that, with the optimum bias point of the parent MZIs 22 being maintained around the Null point (or the peak point), the optimum bias point of the child MZIs 24 is set at the Null point. FIG. 8 is an explanatory view illustrating an example of variation in the heater power for searching for the optimum bias point of the child MZIs 24 in the case where the optimum bias point of the parent MZIs 22 is Quad point+80 degrees, for example, around the Peak point. Note that the horizontal axis represents the time and the vertical axis represents the heater power corresponding to a shift (ΔΦ_{I}, ΔΦ_{Q}) from the Null point of the child MZIs 24. When the optimum bias point of the parent MZIs 22 is around the Peak point, as illustrated in FIG. 8, the Null point of each of the child MZIs 24 gradually shifts over time with ΔΦ_{I}=+ΔΦ_{Q} being maintained. As a result, the Null point of each of the child MZIs 24 shifts over time.

FIG. 9 is an explanatory view illustrating an example of variation in the heater power for searching for the optimum bias point of the child MZIs 24 in the case where the optimum bias point of the parent MZIs 22 is Quad point−80 degrees, for example, around the Null point. Note that the horizontal axis represents the time and the vertical axis represents the heater power corresponding to a shift (ΔΦ_{I}, ΔΦ_{Q}) from the Null point of the child MZIs 24. When the optimum bias point of the parent MZIs 22 is around the Null point, as illustrated in FIG. 9, the Null point of each of the child MZIs 24 gradually shifts over time with ΔΦ_{I}=−ΔΦ_{Q} being maintained. As a result, the Null point of each of the child MZIs 24 shifts over time.

In other words, when the optimum bias point of the parent MZIs 22 is around the Peak Point or the Null point, because there is almost zero control error on the child MZIs 24 under the condition of ΔΦ_{I}−ΔΦ_{Q} or ΔΦ_{I}=+ΔΦ_{Q}, the actual circumstances are that it is not possible to maintain the optimum bias point of the child MZIs 24 at the Null point. Considering the circumstances quantitatively, the expression for calculating the light output power of the optical transmitter 5 obtained in the case where the optimum bias point of the child MZI 24 is at the Null point after performing control to set the optimum bias point of the parent MZIs 22 at the Quad point according to the first embodiment is as expressed by Expression 1.

Pₒᵤₜ∝cos²φ_{I}+cos²φ_{Q}−2cos2φ_{P}·cosφ_{I}·cosφ_{Q} (1)

According to the expression of Expression 1, when the optimum bias point of the parent MZIs 22 is at the Quad point, because the third member in Expression 1 is almost zero, Φ_{I} and Φ_{Q} are minimum values when the optimum bias point of each of the child MZIs 24 is at the Null point.

On the other hand, an expression for calculating the light output power of the optical transmitter 5 obtained in the case where the optimum bias point of the parent MZIs 22 is around the Null point is as expressed by Expression 11.

Pₒᵤₜ∝cos²φ_{I}+cos²φ_{Q}−2cosφ_{I}·cosφ_{Q} (11)

According to the expression of Expression 11, when Φ_{I}=Φ_{Q}, Φ_{I} and Φ_{Q} are approximately zero even when the optimum bias point of the child MZIs 24 is not at the Null point. In other words, even when a bottom search of searching the Null point of the optimum bias point of the child MZIs 24 with the optimum bias point of the parent MZIs 22 being maintained around the Null point (or the Peak point), Φ_{I} and Φ_{Q} are almost zero. It is not possible to maintain the optimum bias point of the child MZIs 24 at the Null point because Φ_{I} and Φ_{Q} are almost zero. Accordingly, because it is not possible to maintain the optimum bias point of the child MZIs 24 at the Null point when the optimum bias point of the parent MZIs 22 is around the Null point, even when the function of turning the light output of the optical transmitter 5 off is started, it is not possible to attenuate the light output of the optical transmitter 11.

Thus, in the first embodiment, when the light output of the optical transmitter 5 is turned off, after bias control is performed to set the optimum bias point of the parent MZIs 22 around the Quad point, bias control is performed to set the optimum bias point of the child MZIs 24 at the Null point.

When the control circuit 13 in the optical coherent transceiver 1 of the first embodiment starts the function of turning off the light output of the optical transmitter 5, after performing control to set the optimum bias point of the parent MZIs 22 around the Quad point, the control circuit 13 controls the voltage output unit 29 such that the optimum bias point of the child MZIs 24 is at the Null point. In other words, after performing control to set the phase difference between the parent MZIs 22 around 90 degrees, the control circuit 13 performs bias control to set the phase difference between the child MIZs 24 at 180 degrees. Even when the light output of the optical transmitter 5 is being off, with the operation of the optical modulator 10 being continued, each of the modulators 25 sets application of the data signal corresponding to the transmission data off. The optimum bias point of each of the child MZIs 24 is at the Null point and accordingly the signal lights passing through the respective child MZIs in the child optical modulator 11B cancel out each other, so that the light output power of the polarization multiplexed signal light that is output by the optical transmitter 5 turns to be almost zero. Furthermore, it is possible to continue a receiving operation of the optical receiver 6, with the output power of the polarization multiplexed signal light from the optical transmitter 5 being set at zero, without stopping the operation of the light source 4. In other words, in the optical coherent transceiver 1, even with light output of the optical transmitter 5 being off, it is possible to continue the operation of the optical modulator 10 and greatly attenuate the light output power. As a result, it is possible to ensure high light off performance without stopping the operation of the light source 4.

Based on the response of the light output power of the normal-phase output in the output stage of the first multiplexer 30 in the optical modulator 10, the control circuit 13 controls the bias voltage to be applied to the child MZIs 24 such that the phase difference between the child MZIs 24 is around 180 degrees. As a result, it is possible to ensure high light off performance without stopping the operation of the light source 4.

When the light output of the optical transmitter 5 is being on (at the time of modulation), the control circuit 13 executes the first search of searching for the optimum bias point of the child MZIs 24 such that the phase difference between the child MZIs 24 is 180 degrees. Furthermore, when the light output of the optical transmitter 5 is being off (at the time of non-modulation), the control circuit 13 executes the second search of searching for the optimum bias point of the child MZIs 24 with a loop gain smaller than that in the first search such that the phase difference between the child MZIs 24 is 180 degrees. As a result, the control circuit 13 is able to search for the Null point of the child MZIs 24 at the time of both modulation and non-modulation.

Note that the case where, in the optical coherent transceiver 1 of the first embodiment, the light output of the optical transmitter 5 is turned off by the function of the optical modulator 10 has been illustrated; however, instead of the function of the optical modulator 10, a variable optical amplifier (VOA) may be arranged for the normal-phase output of the first multiplexer 30 and the embodiment in this case will be described as a second embodiment below.

### [b] Second Embodiment

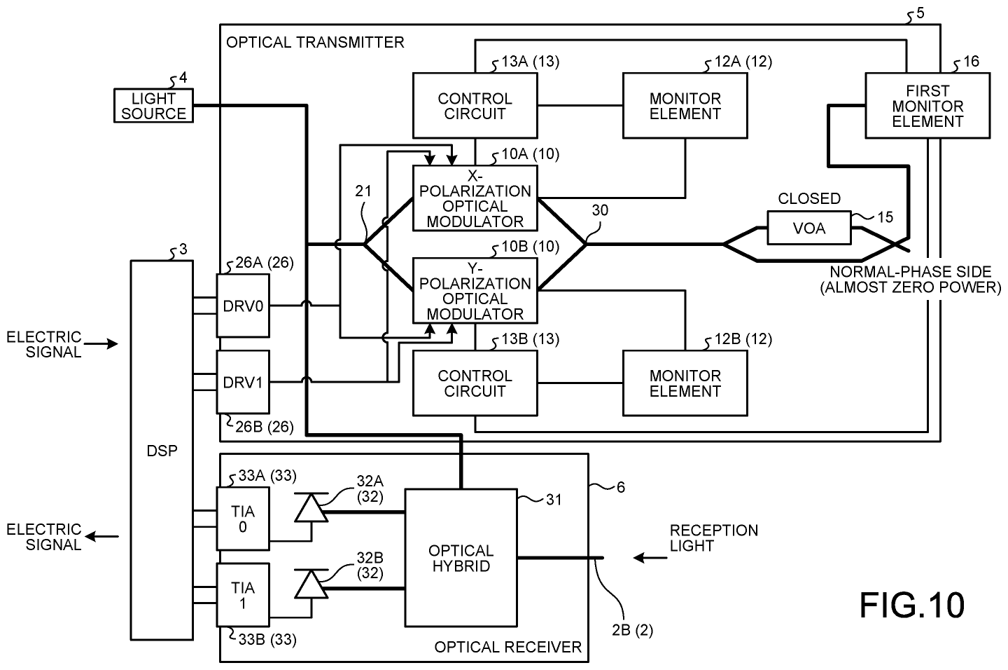

FIG. 10 is a block diagram illustrating an example of a configuration of the optical coherent transceiver 1 of the second embodiment. Note that the same components as those of the optical coherent transceiver 1 of the first embodiment are denoted with the same reference numerals and thus description of redundant components and operations will be omitted. The optical coherent transceiver 1 illustrated in FIG. 10 is different from the optical coherent transceiver 1 illustrated in FIG. 1 in including a VOA 15 that is arranged in the output stage of the first multiplexer 30 and a first monitor element 16 that is arranged in a reversed-phase output stage of the VOA 15. The VOA 15 is an optical attenuator that attenuates the light output power of the normal-phase output of the first multiplexer 30 at the time of non-modulation. As a result, at the time of non-modulation, it is possible to turn the light output of the optical transmitter 5 off completely by the VOA 15 while turning the light output of the optical transmitter 5 off by the function of the optical modulator 10.

The first monitor element 16 detects a response of a light output power of a reversed-phase output of the VOA 15 at the time of non-modulation. Based on the light output power of the reversed-phase output at the time of non-modulation, the control circuit 13 adjusts the optimum bias point of the parent MZIs 22 at a Quad point.

In the optical coherent transceiver 1 of the second embodiment, even when the light output of the optical transmitter 5 is turned off using the VOA 15 at the time of non-modulation, the optimum bias point of the parent MZIs 22 is adjusted at the Quad point based on the response of the light output power of the reversed-phase output of the VOA 15. As a result, even at the time of non-modulation, it is possible to adjust the optimum bias point of the parent MZIs 22 at the Quad point based on the response of the light output power of the reversed-phase output.

For the convenience of illustration, the case where the control circuit 13 executes feedback control to adjust the optimum bias point of the parent MZIs 22 such that the optimum bias point of the parent MZIs 22 is maintained around the Quad point at the time of non-modulation is exemplified. The control circuit 13 however may execute feed forward control to adjust the optimum bias point of the parent MZIs 22 such that the optimum bias point of the parent MZIs 22 is maintained around the Quad point at the time of non-modulation, and changes can be made as appropriate.

In the second embodiment, the polarization multiplexing method in which signal light of a X-polarized wave from the X-polarization optical modulator 10A and signal light of a Y-polarized wave from the Y-polarization optical modulator 10B undergo polarization multiplexing is exemplified and this is applicable to, for example, an optical modulator employing a method without polarization multiplexing.

The case where the control circuit 13 of the first embodiment adjusts the optimum bias points of the parent MZIs 22 and the child MZIs 24 based on the response of the light output power of the polarization multiplexed signal light of the normal-phase output of the first multiplexer 30 is exemplified. The control circuit 13 however may adjust the optimum bias point of the child MZIs 24 based on the response of the light output power of the normal-phase output of the first multiplexer 30 and adjust the optimum bias point of the parent MZIs 22 based on the response of the light output power of the reversed-phase output of the first multiplexer 30.

According to a mode of the optical coherent transceiver, etc., disclosed herein, it is possible to maintain the light-off mode accurately using an optical modulator.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

[symbol]

[symbol]

What is claimed is:

1. An optical coherent transceiver comprising: a light source configured to emit laser light; an optical transmitter including an optical modulator configured to, based on the laser light, perform quadrature amplitude modulation on a data signal and output transmission light;
and an optical receiver configured to, based on the laser light, obtain a data signal from a reception signal that is input, wherein
the optical transmitter includes:
at least a pair of parent Mach-Zehnder interferometers in the optical modulator, the parent Mach-Zehnder interferometer being configured to perform quadrature modulation on the laser light according to a bias voltage;
at least two pairs of child Mach-Zehnder interferometers in the optical modulator, the child Mach-Zehnder Interferometer being configured to perform phase modulation on the laser light according to the bias voltage; and
a control circuit configured to control the bias voltage to be applied to the parent Mach-Zehnder interferometers and the child Mach-Zehnder interferometers, and
the control circuit is configured to, when turning light output of the optical transmitter off, with input of the data signal being set off, control the bias voltage to be applied to the parent Mach-Zehnder interferometers and the child Mach-Zehnder interferometers such that a phase difference between the parent Mach-Zehnder interferometers is around 90 degrees and a phase difference between the child Mach-Zehnder interferometers in each of the pairs is 180 degrees.

2. The optical coherent transceiver according to claim 1, wherein the control circuit is configured to, when turning the light output of the optical transmitter off, with the input of the data signal being set off, after controlling the bias voltage to be applied to the parent Mach-Zehnder interferometers such that the phase difference between the parent Mach-Zehnder interferometers is around 90 degrees, control the bias voltage to be applied to the child Mach-Zehnder interferometers such that the phase difference between the child Mach-Zehnder interferometers in each of the pairs is 180 degrees.

3. The optical coherent transceiver according to claim 1, wherein the control circuit is configured to, when turning the light output of the optical transmitter off, with the input of the data signal being set off, based on a light output power of a normal-phase output of the transmission light of the optical modulator, control the bias voltage to be applied to the child Mach-Zehnder interferometers such that the phase difference between the child Mach-Zehnder interferometers is 180 degrees.

4. The optical coherent transceiver according to claim 1, further including an optical attenuator that is arranged in an output stage of the optical modulator and that is configured to attenuate the transmission light from the optical modulator,
wherein the control circuit is configured to, when turning the light output of the optical transmitter off, with the input of the data signal being set off, based on a light output power of a reversed-phase output of the transmission light of the optical attenuator, control the bias voltage to be applied to the parent Mach-Zehnder interferometers such that the phase difference between the parent Mach-Zehnder interferometers is around 90 degrees.

5. The optical coherent transceiver according to claim 1, wherein the control circuit is configured to, when turning the light output of the optical transmitter on, execute a first search of searching for an optimum bias point of the child Mach-Zehnder interferometers such that the phase difference between the child Mach-Zehnder interferometers is 180 degrees and,
when turning the light output of the optical transmitter off, execute a second search of searching for the optimum bias point of the child Mach-Zehnder interferometers with a gain smaller than that in the first search such that the phase difference between the child Mach-Zehnder interferometers is 180 degrees.

6. A light-off method by an optical modulator, the method comprising turning light output of an optical transmitter off in an optical coherent transceiver including a light source configured to emit laser light; the optical transmitter including an optical modulator configured to, based on the laser light, perform quadrature amplitude modulation on a data signal and output transmission light; and an optical receiver configured to, based on the laser light, obtain a data signal from a reception signal that is input, wherein
the optical transmitter includes
at least a pair of parent Mach-Zehnder interferometers in the optical modulator, the parent Mach-Zehnder interferometer being configured to perform quadrature modulation on the laser light according to a bias voltage;
at least two pairs of child Mach-Zehnder interferometers in the optical modulator, the child Mach-Zehnder Interferometer being configured to perform phase modulation on the laser light according to the bias voltage; and
a control circuit configured to control the bias voltage to be applied to the parent Mach-Zehnder interferometers and the child Mach-Zehnder interferometers, and
the control circuit is configured to turn the light output of the optical transmitter off by, when turning light output of the optical transmitter off, with input of the data signal being set off, controlling the bias voltage to be applied to the parent Mach-Zehnder interferometers and the child Mach-Zehnder interferometers such that a phase difference between the parent Mach-Zehnder interferometers is around 90 degrees and a phase difference between the child Mach-Zehnder interferometers in each of the pairs is 180 degrees.
